(19) United States
(12) Patent Application Publication
(10) Pub. No.: US 2012/0168278 A1
(43) Pub. Date: Jul. 5, 2012

(54) PEOPLE MOVER AND METHOD

(75) Inventors: ARTTU HULT, Helsinki (FI); Esko AULANKO, Kerava (FI); Nithil KARIMPANACKAL NATARAJAN, Helsinki (FI)

(73) Assignee: Kone Corporation, Helsinki (FI)

(21) Appl. No.: 13/342,568

(22) Filed: Jan. 3, 2012

Related U.S. Application Data
(63) Continuation of application No. PCT/FI2010/050571, filed on Jul. 2, 2010.

(30) Foreign Application Priority Data
Jul. 3, 2009 (FI) FI20090265

(51) Int. Cl. B66B 21/00; B66B 23/24; B66B 23/02

(52) U.S. Cl. 198/335; 198/321

(57) ABSTRACT

People mover such as a travelator or the like, includes a plurality of pallets for carrying and moving people. The pallets are arranged one after the other and form an endless track. The track includes an upper track section and a lower track section, and the people mover includes an area of direction change of the pallets where a respective one of the pallets moves between the upper track section and the lower track section. A motor produces the driving force needed to move the pallets. A flywheel is arranged to even out with its rotational energy movement in the travel direction of the pallet track.

### CROSS-REFERENCE TO RELATED APPLICATIONS

This application is a continuation of International Application No. PCT/FI2010/050571, filed Jul. 2, 2010, designating the United States and claiming priority from Finnish Application No. FI 20090265, filed Jan. 3, 2009, the contents of both applications being incorporated herein by reference in their entireties.

### FIELD OF THE INVENTION

The invention relates a people mover such as a travelator, moving ramp, escalator or the like which includes a plurality of pallets to carry and move people. The pallets are arranged one after the other to form an endless track that includes an upper track section and a lower track section. The people mover has an area of direction change of the pallets in which a respective pallet is arranged to move between the upper track section and the lower track section. A motor is coupled to the pallet track to produce a driving force to move the pallets in a travel direction.

The invention also relates to a method for evening out movement in a travel direction of a pallet track of a people mover of the above type.

The invention further relates to a second people mover such as a travelator, moving ramp, escalator or the like, that includes a power transmission having a transmission chain; and a plurality of pallets arranged one after the other to form an endless track for carrying and moving people, the track having an upper track section, a lower track section, and an area of direction change of the pallets in which area a pallet is arranged to move between the upper track section and the lower track section, and wherein the pallets are arranged successively close to each other to form an essentially continuous conveying surface and connected to the transmission chain.

### BACKGROUND OF THE INVENTION

In known travelator arrangements, people are moved on consecutive pallets, which form a continuous moving track. The pallets are connected to each other with a transmission chain, the pulling of which moves the pallets. The chain is connected to a pallet with, for instance, a pin in the center part of the pallet, which pin is mounted on a bearing that allows it to rotate in relation to the pallet. The pallet track formed by the pallets comprises an upper track section, i.e. a conveyor part, on which the passengers can stand or walk, and a lower track section, i.e. a return part, the pallets of which return part move below the pallets of the conveyor part and in the opposite direction in relation to them. Both ends of the conveyor have an arrangement for turning the direction of the pallets and for moving the pallets between the conveyor part and the return part. When moving a pallet between the conveyor part and the return part, it is guided to travel a curved path of movement until its direction of movement has turned to the desired direction. This is most generally done such that a diverting pulley turns the direction of movement of the transmission chain, to which diverting pulley each pallet is fixed, in which case the pallet experiences a direction of movement in the area of the direction change of the path of movement according to a circular curve. A problem with known systems is that when the direction of movement of a pallet is turned, the pallets in the area of turning exert variable forces on the transmission chain, which causes pulsations in the chain in its longitudinal direction and which can be transmitted to the passengers on the conveyor section as jerking and thus cause discomfort.

The aforementioned variable forces in the area of turning are caused by the fact that when a pallet is moved between the upper track and the lower track the direction of movement of the pallet changes gradually from horizontal movement into vertical movement. When a pallet is changing direction it switches to being supported by the chain and the chain supports the pallet in the vertical direction during the change of direction. When pallets are between the areas of direction change, i.e. on the upper track or on the lower track, the pallets are supported in the vertical direction by means of guides. Each pallet on the upper track and on the lower track is supported on guides under the rolls, along which guides the pallet travels. When supported in the vertical direction on the guides, the mass of the pallet does not directly hang from the chain but instead the mass mainly produces rolling resistance on the pallet, at least on the horizontal sections of the people mover.

It has been noticed that, from the viewpoint of drive comfort, it is important to reduce the pulsation of the pallet track, which pulsation is produced when raising a pallet from the lower track to the upper track at the end opposite the drive end when driving forwards (=the motor pulls the load of the upper track). Work needs to be performed for moving a pallet from the lower track to the upper track, to the extent of the change of the potential energy of the pallet. A corresponding force variation is caused, however, also when a pallet is moved from the upper track to the lower track.

Alongside the aforementioned reasons, the pallets produce a variation in the chain/elsewhere in the pallet track owing to centrifugal forces, because the pallet is controlled to change its direction with such a small radius that the change of direction event increases momentarily the force exerted on the chain.

The aforementioned phenomena cause problems also at the drive end, i.e. at the end to which the motor is connected. The effect of the problems depends on the arrangement with which power is transmitted from the motor to the chain, but e.g. when the motor is connected in a driving manner to the diverting pulley of the chain, which diverting pulley drives the chain, the pallets in a change of direction at both ends can simultaneously cause a pulsating additional load between the motor and the driving diverting pulley, which can cause problems, e.g. wearing of the transmissions or noise.

Owing to low chain tension, the pulsation described above causes problems more particularly in travelators, since the pulsation generated is in an awkward range for a passenger from the viewpoint of ride comfort because the natural frequency of a standing person is, for a person of medium height, in the same range as the pulsation. From the viewpoint of a passenger this means quite an unpleasant situation. When the walking frequency of a person is also in the same range (1 . . . 2 Hz depending on how hurried), the situation is quite awkward.

### OBJECTS OF THE INVENTION

An object of the invention is to eliminate, among others, the aforementioned drawbacks of known people mover systems. More particularly it is an object of the invention is to produce a more advanced people mover, preferably a travelator or the like. Further, it is an object of the invention is to produce a people mover, the ride comfort of which is better than before. Even more particularly, the invention has objects that include achievement of one or more of the following advantages:
A people in which the ride comfort is better than before.
A people mover in which the pulsation of the track is less than before.
A people mover in which interference susceptibility to changes in the load of which is less than before.
A people mover in which the noise produced is less than before.
A people mover in which the wear of parts of which can be reduced and the service life of the parts improved.
A people mover and method with which the excitation generated by raising a pallet can be damped.
A people mover in which the amplitude of vibration of which is more advantageous than before.
A method with which the amplitude of the vibration of a people mover can be changed to be advantageous.

### SUMMARY OF THE INVENTION

The above and other objects are accomplished according to the invention by the provision of a people mover as first described above wherein according to one embodiment there is additionally provided a flywheel coupled to the motor and arranged to even out movement of the pallets in the travel direction with use of rotational energy of the flywheel.

According to a further aspect of the invention there is provided a method for evening out movement in a travel direction of a pallet track of a people mover as first described above wherein in one embodiment the method additionally includes employing rotational energy of a flywheel to reduce pulsation caused by a change of direction of the pallets.

The second people mover according to the invention as first described above further includes a movable diverting pulley that turns a direction of the transmission chain; a rotating apparatus; a unit movable in a horizontal direction for tensioning the transmission chain, wherein the movable unit includes tensioning wheels, and the movable diverting pulley moves along with the unit when the unit is moved; and a second diverting pulley connected to the movable diverting pulley, the power transmission transmitting rotational movement between the rotating apparatus and the movable diverting pulley, which rotating apparatus is supported in its position in a manner allowing rotation and is connected to the movable diverting pulley with a second power transmission including a third diverting pulley and a tensioning belt coupling the second and third diverting pulleys, wherein a tensioning of the tensioning belt is arranged utilizing the tensioning wheels of which at least one is spring-loaded to move towards the tensioning belt, wherein the tensioning wheels are arranged such that at least one of them steers the tensioning belt such that an angle is formed in the tensioning belt.

Other embodiments of the invention are characterized by what is disclosed in the other claims. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the framework of the basic inventive concept in conjunction with other embodiments.

Thus, according to one embodiment, the people mover of the invention includes a travelator or like, comprising a plurality of pallets or or the like for carrying and moving people, which pallets are arranged one after the other and form an endless track, which track comprises an upper track section and a lower track section, and which people mover comprises an area of direction change of the pallets or the like, when in which area a pallet is arranged to move between the upper track section and the lower track section (and to move in this case in the vertical direction), and a motor for producing the driving force needed to move the pallets or the like. The people mover comprises a flywheel, which is arranged to even out with its rotational energy the movement in the travel direction of the pallet track (particularly by reducing pulsation, more particularly pulsation that is caused by a change of direction of the pallets). The pulsation produced by a change of direction of the pallets is an intermittent force variation in the travel direction of the pallet track exerted on the power transmission of the pallets and is thus also transmitted to the pallets of the conveyor part, causing unevenness in the movement of the pallets of the pallet track and manifests as jerk. Correspondingly, the solution is also suited to pulsation, which is a force variation in the travel direction of the pallet track exerted on the power transmission of the pallets, that may be caused by other reasons.

In one embodiment of the invention the motor is connected via the power transmission to the pallets and a flywheel is connected to the aforementioned power transmission. The flywheel receives its rotational energy from the motor (via the power transmission) and is arranged to rotate when the pallets move and to even out the movement of the pallet track with its rotational energy.

In one embodiment of the invention the flywheel is connected to the power transmission, preferably to the transmission chain or the like of the power transmission, essentially rigidly. In this way the flywheel does not in itself produce detrimental pulsation and is simple and effective in preventing problems caused by a change of direction. Force can thus be conducted from the flywheel essentially without delay to the transmission chain, and thus a detrimental stress impulse caused by a pallet that is in a change of direction is not able to pass onwards along the transmission chain. The aforementioned rigid connection is preferably as rigid as possible.

In one embodiment of the invention a flywheel is essentially rigidly connected to the transmission chain via the diverting pulley that guides the transmission chain, to which diverting pulley the flywheel may be connected with a power transmission, most preferably with a belt or the like, and with diverting pulleys. In this way a compact and effective solution is achieved. A belt has an advantage of being noiselessness and a simple friction coupling option can be used that yields in a problem situation. Alternatively, instead of a belt a chain or even a gear wheel transmission could be used.

In one embodiment of the invention when the people mover (1) is moving at normal drive speed, which is preferably 0.5-2 m/s, the speed of rotation of the flywheel (8) is over 200 rpm, preferably over 300 rpm, even more preferably over 400 rpm.

In one embodiment of the invention the mass of the flywheel is over 10 kg, preferably over 20 kg, even more preferably 30 kg or over. The mass of the flywheel is in this case so big in relation to the mass of the pallet or the like that the forces produced in it by the raising of a pallet do not essentially slow down its speed of rotation.

In one embodiment of the invention the mass of an individual pallet or the like is less than 40 kg, preferably less than 35 kg, most preferably approx. 30 kg.

In one embodiment of the invention the flywheel is arranged to even out with its rotational the energy movement of the pallet track by conveying its kinetic energy to the power transmission means (preferably at least during movement of a pallet between the upper track and the lower track).

In one embodiment of the invention the rotational energy of the flywheel when the people mover is moving is essentially greater than the kinetic energy of an individual pallet or the like.

In one embodiment of the invention the rotational energy of the flywheel when the people mover is moving is in the same order of magnitude as the total kinetic energy of all the pallets.

In one embodiment of the invention the inertia of the flywheel is over 0.5 kgm², preferably over 1.0 kgm², even more preferably over 1.5 kgm², most preferably of all 2.0 kgm² or more, and
when the people mover is moving at normal drive speed the speed of rotation of the flywheel is over 200 rpm, preferably over 300 rpm, even more preferably over 400 rpm, and
the speed of movement of the pallets of the people mover when the people mover is moving at normal drive speed is over 0.5 m/s, preferably 0.5-2 m/s, and
the mass of an individual pallet is less than 40 kg, preferably less than 35 kg, most preferably approx. 30 kg.

In one embodiment of the invention the flywheel is arranged at the end of the people mover, which is the end where the pallets or the like rise from the lower track to the upper track (the flywheel is connected to the power transmission 2,6 at the end in question for this reason). In this case, that is where the excitation that is characteristic to the system will be generated and thus the excitation produced by raising a pallet can be damped. This is based on the fact that the flywheel lifts the pallet from the lower track to the upper track with its rotational energy.

In one embodiment of the invention the flywheel is arranged at the end of the people mover, which end is the opposite end to the end which comprises the motor.

The flywheel and the motor therefore cut the chain into two separate systems that are independent of each other. This means that because of the motor or the flywheel vibrations do not pass from one track to the other through the area of the direction change and, that being the case, dynamically the system changes and so does its natural frequencies. Thus the lowest natural frequencies can be moved out of this rather awkward 1-2 Hz frequency range. The term mass attenuation or the non-impedance attenuation is used in other contexts for the same phenomenon. The amplitude of the vibration also changes from this effect because the whole pallet mat can be interpreted as one long spring, and when halving the length of the spring, of course, the length of movement produced by the same excitation also halves.

In one embodiment of the invention the flywheel is connected to the diverting pulley that turns the direction of the transmission chain or the like, which diverting pulley is preferably a gear wheel.

In one embodiment of the invention the flywheel is connected via a power transmission, preferably via a belt and a diverting pulley, to the power transmission of the people mover, preferably to the diverting pulley that guides the transmission chain.

In one embodiment of the invention the flywheel is inside the projection of the loop formed by the handrail belt, as viewed in the direction of the center of bending of the loop. An advantage of this is a compact structure.

In one embodiment of the invention the flywheel is at least partly, preferably fully, inside the loop formed by the handrail belt. An advantage of this is a compact structure.

In one embodiment of the invention the flywheel is connected to the transmission chain or the like via the diverting pulley that guides the transmission chain or the like, to which diverting pulley the flywheel is preferably connected with a power transmission, most preferably with a belt or the like, and with diverting pulleys such that there is a transmission ratio between the runner wheel and the diverting pulley, by means of which ratio their angular velocities are arranged to differ from each other. The speeds of rotation can be optimized by means of the transmission of the power transmission such that an impulse is not regularly exerted on the runner wheel and/or the power transmission when it/they are in the same position/ratio to each other. Thus the number of impulses experienced by the different parts of the power transmission can be evened out and a longer service life for the power transmission and for the bearing(s) of the flywheel is achieved.

In one embodiment of the invention the flywheel is inside the loop formed by the handrail, preferably in the proximity of the turning point of the handrail belt at the end of the people mover, inside the casing that is inside the loop formed by the handrail belt. One advantage of this is a compact, safe and simple structure.

In one embodiment of the invention the people mover comprises a support, on which the flywheel rests for support. The support is preferably mounted on the frame of the travelator and/or on the floor of the building. If the support structures are supported on the floor, they are preferably separate support structures from the frame of the people mover for conducting forces away from the people mover.

In one embodiment of the invention the people mover comprises two transmission chains connected to the pallets, preferably on opposite sides of the pallets, and a synchronization shaft, which connects the aforementioned two transmission chains or the like into an entity that moves in synchronization. Power is transmitted via the synchronization shaft between the aforementioned two chains or the like, and the synchronization shaft is connected to the flywheel via a belt, chain or the like. In this case one advantage is that with one flywheel the pulsation of more than one transmission chain or the like can be evened out.

In one embodiment of the invention the people mover may comprise two flywheels, preferably such that two transmission chains, which are connected to the pallets and are preferably on opposite sides of the pallets, may each be connected to their own flywheels.

In one embodiment of the invention the flywheel is at the tensioning end of the transmission chain or the like.

In one embodiment of the invention the pallet is connected to the chain from the area between the ends of the pallet, e.g. in a hinged manner.

In one embodiment of the invention the pallet retains its attitude in the change of direction.

In one embodiment of the invention the flywheel is connected to the power transmission of the pallet track at the non-driven end of the people mover.

In one embodiment of the invention the transmission chain or the like is integrated as a part of the endless pallet track, in which case the pallets or the like are connected to each other as if into a chain.

In one embodiment of the invention the flywheel is inside the projection of the loop formed by the handrail belt, as viewed in the direction of the center of turning of the loop (this is preferably parallel with the center of rotation/shaft of the flywheel). In this way a compact and simple people mover is achieved with a good drive comfort. The placement of the flywheel is efficient and its possibly large radius does not cause problems.

In one embodiment of the invention the flywheel is at least partly, preferably fully, inside the loop formed by the handrail belt. In this way a compact and simple people mover is achieved.

In one embodiment of the invention the flywheel is, in relation to the power supply and as viewed from the motor, downstream with respect to the pallets of the conveying part or of the return part.

In one embodiment of the invention the flywheel is inside the handrail casing that is inside the loop formed by the handrail belt, preferably in the proximity of the turning point of the handrail belt at the end of the people mover. In this way a people mover that is compact in all directions and a simple esthetic appearance are achieved.

In one embodiment of the invention the flywheel is connected to the transmission chain or the like via the diverting pulley that guides the transmission chain or the like, and the flywheel and the diverting pulley are supported separately from each other. Thus the flywheel can be firmly supported in its position in the manner desired, and the flywheel and the aforementioned diverting pulley do not disturb each other.

In one embodiment of the invention the flywheel is essentially a solid metal disk. Thus its inertia (I) is simply adjustable to the desired constant value.

In one embodiment of the invention the flywheel is arranged at the end of the people mover, at which end there is no motor for producing the driving force needed to move the pallets or the like. Thus the flywheel evens out the passage of the travelator at the non-drive end.

In one embodiment of the invention the people mover also comprises a brake for the flywheel, which brake acts on the flywheel separately from the power transmission that moves the flywheel. Thus the solution is safe in emergency braking.

In one embodiment of the invention somewhere between the flywheel and the power transmission that moves the flywheel is a coupling, e.g. a friction coupling, which releases the otherwise essentially rigid connection between the flywheel and the power transmission such that the flywheel can continue rotation although the power transmission is stopping or has stopped. Thus the solution is safe in emergency braking.

In one embodiment of the invention the pallets or the like are arranged successively close to each other so as to form an essentially continuous conveying surface.

In one embodiment of the invention the flywheel is a solid object. In this way the flywheel does not in itself produce pulsation and is simple.

In one embodiment of the invention the inertia of the flywheel is constant. In this way the flywheel does not in itself produce pulsation and is simple.

In one embodiment of the invention the center of rotation of the flywheel is higher than the pallet track. In this way a compact people mover is achieved.

According to the invention, there is provided a method for evening out the movement in the travel direction of a pallet track or the like of a people mover, more particularly in a travelator or the like, which comprises a plurality of pallets or the like for carrying and moving people, which pallets are arranged one after the other and form an endless track, which track comprises an upper track section and an lower track section, and which people mover comprises an area of direction change of the pallets or the like, when in which area a pallet or the like is moved between the upper track section and the lower track section (and to move in this case in the vertical direction), and a motor for producing the driving force needed to move the pallets or the like. In the method, pulsation, preferably at least pulsation caused by a change of direction of the pallets, is reduced with the rotational energy of a flywheel.

In one embodiment of the invention pulsation is reduced with a flywheel, which is connected to the power transmission of the pallet track.

In one embodiment of the invention, pulsation is reduced with a flywheel, which is essentially rigidly connected to the power transmission of the pallet track. In this way a small delay in the effect of the flywheel is achieved.

In one embodiment of the invention pulsation is reduced with the rotational energy of the flywheel, which rotational energy is conveyed to the power transmission when moving a pallet from the lower track to the upper track.

In one embodiment of the invention pulsation is reduced with the rotational energy of the flywheel, at the end of the people mover, which end is the opposite end to the end which comprises the motor, and at which end the pallets or the like preferably rise from the lower track to the upper track.

In one embodiment of the invention pulsation is reduced with a flywheel, which is connected to the power transmission of the pallet track at the non-driven end of the people mover.

According to another embodiment of the invention there is provided a people mover, more particularly a travelator, moving ramp, escalator or the like, that comprises a plurality of pallets or the like for carrying and moving people, which pallets are arranged one after the other to form an endless track, which track comprises an upper track section and a lower track section, and which people mover comprises an area of direction change of the pallets, in which area a pallet is arranged to move between the upper track section and the lower track section, and which pallets are arranged successively close to each other to form an essentially continuous conveying surface and are connected to a transmission chain or the like. According to this embodiment of the invention, the people mover comprises a unit that is movable in the horizontal direction for tensioning the transmission chain, and a first diverting pulley that turns the direction of the transmission chain, which moves along with the unit when it is moved, and a second diverting pulley connected to the first diverting pulley, a rotating apparatus supported in its position in a manner allowing rotation and being connected to a rotating part such as the second diverting pulley by a power transmission that includes, for example a third diverting pulley connected to the rotating apparatus and a belt that couples the third diverting pulley to the second diverting pulley to transmit rotational movement between the rotating apparatus and the transmission chain, wherein a tensioning of the belt is arranged utilizing tensioning wheels, of which at least one is spring-loaded so that toward the belt, which tensioning wheels are arranged such that at least one of them, but preferably both, steer the belt such that an angle is formed in the belt. An advantage of this embodiment is that the aforementioned apparatus that rotates in its position can be connected to the moving diverting pulley with a belt such that the belt stays at a good tightness, and the diverting pulley can be moved without a problem. Thus e.g. the motor or runner wheel can be simply and operationally reliably disposed at the tightening end of the transmission chain.

In one embodiment of the invention, two tensioning wheels can each be moved towards and away from the belt, to adjust the tightness of the belt.

One embodiment of the invention comprises a tensioning wheel that tightens the belt loop from inside and a tensioning wheel that tightens the belt loop, or maintains the tightness of same, producing a counterforce, from the outside. In this way two angles can be produced in the belt, and an adjustment tolerance can be added.

### BRIEF DESCRIPTION OF THE DRAWINGS

In the following, the invention will be described in detail by the aid of some embodiments with reference to the attached drawings, wherein

FIG. 1a-1b presents an embodiment of a people mover according to the invention.

FIG. 2 presents another embodiment of a people mover according to the invention.

### DETAILED DESCRIPTION OF THE INVENTION

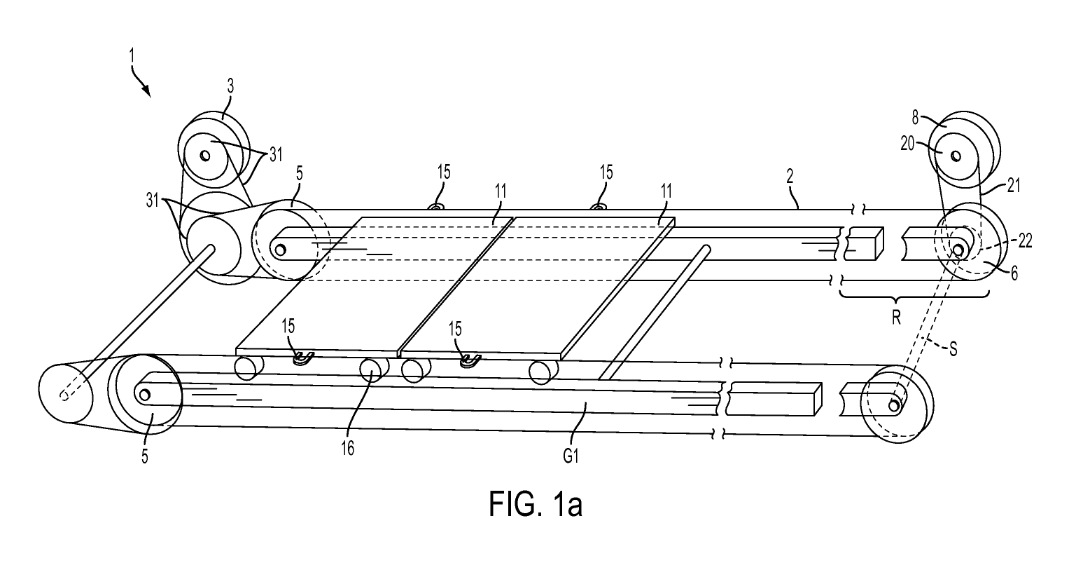

FIG. 1a presents a people mover 1 according to an embodiment of the invention. The people mover 1 shown in FIG. 1a is a travelator, wherein the pallets 11 conveying passengers are arranged to move supported on rolls 16 with guides. The pallets 11 are arranged successively close to each other to form an essentially continuous conveying surface (only some of the pallets are shown) and connected to a transmission chain or the like 2 with coupling elements 15, which transmission chain 2 is arranged to move the pallets 11 with the power transmitted from a motor 3. The transmission chain can be a jointed chain type or a belt type. The transmission chain 2 is formed into an endless loop and passes around turning elements 5 and 6, which are most preferably gear wheels or diverters, and when passing around the diverters, the chain turns the travel direction of a pallet and at the same time moves the pallet between the upper track U and the lower track L, i.e. between the conveyor part and the return part. The people mover 1 also comprises a flywheel 8, which is arranged to even out movement of the pallet track with its rotational energy, wherein flywheel energy is stored in the form of rotational movement.

The flywheel is arranged to rotate when the pallets move and receives its rotational kinetic energy from the motor 3, which is connected via a power transmission 31,2,6 to the pallets 11. For this reason a flywheel 8 is connected to the aforementioned power transmission, and is thus arranged to even out with its rotational energy the movement of the pallet track, more particularly pulsation-type movement in the travel direction of the pallet track that is caused by the change-of-direction action of the pallets in the area of the change of direction R of the pallets. The flywheel is connected to the power transmission, more particularly to the chain 2, such that it receives kinetic energy from the chain and is able to convey kinetic energy to the chain. The flywheel 8 is essentially rigidly connected to the transmission chain 2 via the diverting pulley 6 that guides the transmission chain, to which diverting pulley the flywheel 8 is connected with a power transmission, in the embodiment presented in the figure with a belt 21 and with diverting pulleys 20, 22 (which belt 21 is preferably a V-belt).

FIG. 1b presents some details of the area of the direction change of the people mover 1 of FIG. 1a. In FIG. 1b the pallet on the extreme right-hand side is being moved from the lower track L to the upper track U such that the attitude of the pallet 11 remains the same during the change of direction. When the pallet in question is in the position presented it is supported in the vertical direction resting on the transmission chain 2 and the diverting pulley 6. In this case the mass of the pallet exerts a force on the transmission chain in the longitudinal direction of transmission chain, which force is at its greatest when the pallet is in the position presented and which force decreases as the pallet continues its movement to the left in the FIG. 1b. In order to reduce this force variation the people mover according to the invention comprises a flywheel 8, which is able to convey its rotational energy to the diverting pulley 6 and/or to the chain 2, thus helping in moving the pallet 11 from one level to another. The mass of the flywheel is chosen to be large in relation to the mass of the pallet so that the forces produced in the flywheel in raising the pallet do not essentially slow down speed of rotation of the flywheel. Thus the flywheel rotates essentially at a constant speed regardless of the position of the pallets and prevents/reduces a force variation being exerted on the transmission chain as a result of a change in the vertical position occurring in the area of direction change R of the pallets 11. Correspondingly, the significance of centrifugal forces produced by the turning of a pallet decreases owing to the flywheel, so that also the force variation caused by centrifugal forces is essentially prevented/reduced owing to the flywheel. FIG. 1b presents the guides G2 of the lower track L, which are not shown in FIG. 1a for the sake of clarity.

In FIGS. 1a-1b the people mover according to the invention is presented schematically. The flywheel is supported in its position in a manner allowing rotation and is connected to the diverting pulley 22 rotated by the diverting pulley 6 with a belt 21.

The people mover 1 presented comprises two transmission chains 2 connected to the pallets 11 on opposite sides of the pallets (the presence of two chains is not, however, necessary). If it is desired to even out the forces of the second transmission chain as well, a flywheel 8 can be used to also even out the forces of the second chain, e.g. by a synchronization shaft S presented in FIG. 1a with a dashed line, which synchronization shaft connects the aforementioned two transmission chains 2 into an entity that moves in synchronization. Force, e.g. driving force, can also be transmitted between the aforementioned two chains or the like via the same synchronization shaft S. The synchronization shaft S is rigidly connected to the diverting pulleys of both chains as well as to the flywheel 8, in which case the forces that are transmitted from the flywheel are transmitted to both transmission chains. Alternatively, the lower chain in FIG. 1a could be provided with its own flywheel arrangement, which functions in a corresponding manner to the force balancing arrangement comprising the flywheel 8, in which case the dimensioning of the flywheels can be made to be lighter and/or their speed of rotation can be fitted to be lower.

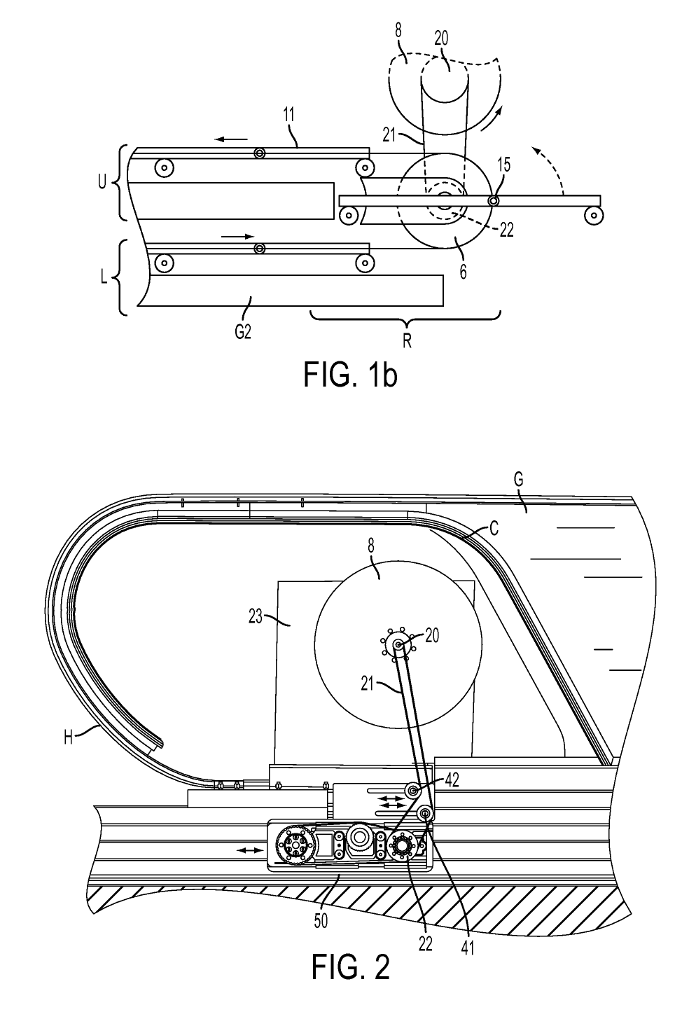

FIG. 2 presents an embodiment for implementing the arrangements illustrated by the schematics of FIGS. 1a-1b. In FIG. 2, the flywheel 8 is inside the projection of the loop formed by the handrail belt H, as viewed in the direction of the center of bending of the loop (in the FIG. 2, parallel with the center of rotation/axis of the flywheel). In addition, the flywheel 8 is at least partly, preferably fully, inside the loop formed by the handrail belt, e.g. in FIG. 2 as viewed from above the flywheel is at least partly aligned with the belt H. Likewise the flywheel 8 is inside the handrail casing C that is inside the loop formed by the handrail belt, at the end of the people mover in the proximity of the turning point of the handrail belt (preferably less than 3 m from the end of the belt H). The people mover 1 comprises a support 23, on which the flywheel 8 is supported. Support structures of support 23 are may be mounted on the frame of the travelator as presented in FIG. 2. They can be simultaneously or alternatively mounted on the floor of the building. When the support structures are supported on the floor, they can be support structures essentially separate from the frame of the people mover for conducting forces away from the people mover. The flywheel 8 is connected via a power transmission, preferably via a belt 21, to the power transmission (2,6,31) of the people mover, more particularly such that forces can be transmitted in both directions between them (e.g. rigidly). More precisely, the belt 21 is connected to the diverting pulley 22, which is essentially rigidly connected to the diverting pulley 6 (not shown in FIG. 2) that guides the transmission chain. The aforementioned diverting pulley 6 can be co-axial with the diverting pulley 22 (see FIGS. 1a, 1b) but it could also be connected with a power transmission (such as the belt presented) so as to be separate from the diverting pulley 22. Additionally, FIG. 2 presents a tensioning arrangement of a belt 21 (not necessary), in which the tensioning of the belt may be arranged utilizing tensioning wheels. The tensioning wheels 41, 42 can each be moved towards and away from the belt 21, with which movement the tightness of the belt 21 can be adjusted. At least one of the tensioning wheels 41, 42 may be spring-loaded (with a spring or the like) so that it tries to move towards the belt, in which case the other tensioning wheel can be e.g. tightened into its position or can also be spring-loaded. The tensioning wheels are arranged such that at least one of them, but preferably both, steer the belt 21 so that an angle is formed in the belt. The arrangement presented in the FIG. 2 comprises a tensioning wheel 41, which tightens the belt loop from inside, and a tensioning wheel 42, which tightens the belt loop (or maintains the tightness of same, producing a counterforce, if it is not spring-loaded) from the outside. The angle produced by the spring-loaded tensioning wheel(s) 41 and/or 42 in the belt 21 is so great that moving the spring-loaded tensioning wheel(s) within the scope of the movement allowance of the spring load results in an essential lengthening of the distance between the diverting pulleys 20 and 22 of the belt being enabled as a consequence of the straightening of the belt. The aforementioned lengthening is so great that it allows movement of the diverting pulley 22 by at least 10 cm in the horizontal direction, preferably over 15 cm, even more preferably 20 cm. This freedom of movement is necessary because it must be possible to move (as presented by the arrow in the FIG. 2) the turning unit 50 of the pallets or the like in the horizontal direction to tighten the transmission chain 2 or the like. Since the diverting pulley 22 is connected to the power transmission (2,6,31), more particularly to the diverting pulley 6 that turns the chain, the diverting pulley 22 must move because the diverting pulley 6 moves along with the turning unit 50 when it is moved. In this case also some other rotating unit, e.g. a motor, can be utilized in place of the flywheel 8. The arrangement is particularly advantageous when, owing to the tensioning of the transmission chain, the turning unit 50 is a moving one and it has been necessary to connect a rotating apparatus in a stationary position to the rotating part of the turning unit with a power transmission (e.g. 21), which power transmission transmits rotational movement between the rotating apparatus and the rotating part of the turning unit.

The travelator presented in the figures may be a travelator that is installed on top of a floor, in which travelator the motor is above the floor level, preferably inside the handrail.

In the embodiments described above, the large inertia (I) and the speed of rotation of the flywheel 8 increase its effect. The inertia (I, momentum of inertia) is preferably over 0.5 kgm², preferably over 1.0 kgm², even more preferably over 1.5 kgm², most preferably of all 2.0 kgm² or more. When the people mover 1 is moving at normal drive speed the speed of rotation of the flywheel 8 can be with any of the aforementioned momenta of inertia whatsoever over 200 rpm, preferably over 300 rpm, even more preferably over 400 rpm. The faster the speed of the travelator is, the greater the rotational energy preferably is. The pallets 11 of the people mover can move when traveling at normal drive speed e.g. at a speed of 0.6 m/s-0.8 m/s. The adverse effect caused by pulsation of the mass of an individual pallet 11 is greater the greater the mass is. The mass of an individual pallet with any of the preceding given values whatsoever is less than 40 kg, preferably less than 35 kg, most preferably approximately 30 kg. The mass of the flywheel is preferably over 10 kg, preferably over 20 kg, even more preferably 30 kg or over. The flywheel can be an essentially solid metal disk. The radius of turn of a pallet can be e.g. in the range of 5-10 cm, preferably 5-20 cm, but can of course be also larger in some cases. If more than one flywheel is used, the aforementioned values affecting the rotational energy of a flywheel can be divided among the flywheels appropriately such that the rotational energies of the flywheels are the same among themselves.

In the method according to the invention for evening out the movement in the travel direction of the pallet track of a people mover 1, more particularly in a travelator or the like, which comprises a plurality of pallets or the like for carrying and moving people, which pallets are arranged one after the other and form an endless track, which track comprises an upper track section and a lower track section, and which people mover comprises an area of direction change of the pallets, in which area a pallet is moved between the upper track section and the lower track section (and to move in this case in the vertical direction), and a motor 3 for producing the driving force needed to move the pallets, pulsation caused by a change of direction of the pallets is reduced with the rotational energy of a flywheel. A people mover according to FIGS. 1-2 is preferably used here. More particularly, pulsation is reduced with the flywheel 8 connected to the power transmission 2,6,31 of the pallet track, in which case pulsation is reduced with the rotational energy of the flywheel 8, which rotational energy is conveyed to the power transmission when moving a pallet from the lower track to the upper track. Preferably rotational energy is conveyed essentially not at all between moves, but instead the power transmission can transfer more rotational energy to the flywheel 8. Pulsation is preferably thus reduced at the end of the people mover, which end is the opposite end to the end which comprises the motor, and at which end the pallets rise from the lower track to the upper track.

For emergency stops, the people mover can also comprise a brake that acts on the flywheel separately from the power transmission (e.g. from the belt 21) that moves the flywheel. In this case the brake can act e.g. directly on the structure of the flywheel. Alternatively, somewhere between the flywheel and the power transmission that moves the flywheel is a coupling, e.g. a friction coupling, which releases the otherwise essentially rigid connection between the flywheel and the power transmission such that the flywheel can continue slowly decelerating rotation although the power transmission is suddenly stopping or has suddenly stopped. The function in question is most preferably enabled, however, if the belt 21 is able to slip on the diverting pulley 20 and/or 22, if large acceleration or braking is exerted on the power transmission, the absolute value of which acceleration or braking exceeds a certain predetermined value. In this case the belt 21 is preferably a non-toothed belt e.g. a V-belt or a flat belt, and the diverting pulley possesses a shape suited to the belt.

It is obvious to the person skilled in the art that the invention is not limited to the embodiments described above, in which the invention is described using examples, but that many adaptations and different embodiments of the invention are possible within the frameworks of the inventive concept defined by the claims presented below. Thus it is obvious that the transmission chain or the like can be a separate part from the pallets in the manner presented in the embodiments of the figures of this application, but the transmission chain or the like could alternatively be integrated as a part of the endless pallet track, e.g. in a solution wherein the pallets of the pallet track are attached in a chain-like fashion to each other such that the force moving the pallets is transmitted from one pallet to another. It is also obvious that the drive direction of the travelator can differ to what is presented and the flywheel can be at either end whatsoever of the people mover evening out the transfer of the pallets between the upper track and the lower track in either direction whatsoever, or it can be disposed, for instance, in the area between the ends. The flywheel presented is a so-called “idle wheel”. It does not have a motor on its shaft. As is also presented in the examples above, it is thus not advantageous to implement the infeed of the rotational force of the conveyor of a travelator directly via a flywheel, but instead the force is transmitted to the conveyor, to the pallets, with power transmission from which also the flywheel receives its rotational energy. In other words the flywheel is, in relation to the power supply and as viewed from the motor, downstream with respect to the pallets of the conveying part or of the return part, as can be seen from the figures.

A pallet or the like refers to the fact that the objects to be transported could alternatively be, instead of pallets, some corresponding object such as e.g. a stair step, etc. For simplicity, the use herein of “pallet” or “pallets” by themselves is intended to comprehend such corresponding objects. Transmission chain or the like refers to the fact that the power transmission can alternatively be, instead of a chain, some corresponding means, such as e.g. a flat belt, a V-belt, a cogged belt, a rope, etc. For simplicity, the use herein of the phrase “transmission chain” by itself is intended to comprehend such corresponding means. It is also obvious that the invention can be utilized in different people movers, such as in travelators, escalators, moving ramps and the like.

1. A people mover such as a travelator, moving ramp, escalator or the like, comprising:
a plurality of pallets to carry and move people, the pallets being arranged one after the other to form an endless track that includes an upper track section and a lower track section, the people mover having an area of direction change of the pallets, in which a respective pallet is arranged to move between the upper track section and the lower track section;
a motor coupled to the pallet track to produce a driving force to move the pallets in a travel direction; and
a flywheel coupled to the motor and arranged to even out movement of the pallets in the travel direction with use of rotational energy of the flywheel.

2. The people mover according claim 1, further including a first power transmission by which the motor is coupled to the pallets, wherein the flywheel is coupled to the first power transmission and receives rotational energy from the motor, the flywheel being arranged to rotate when the pallets move and to even out the movement of the pallet track with said rotational energy.

3. The people mover according to claim 2, wherein the first power transmission includes a transmission chain, and the flywheel is substantially rigidly connected to the transmission chain.

4. The people mover according to claim 1, wherein the speed of rotation of the flywheel is over 200 rpm when the people mover is moving at a drive speed of 0.5-2 m/s.

5. The people mover according to claim 1, wherein the mass of the flywheel is over 10 kg.

6. The people mover according to claim 1, wherein the mass of an individual pallet is less than 40 kg.

7. The people mover according to claim 1, wherein the inertia of the flywheel is over 0.5 kgm.

8. The people mover according to claim 1, wherein the flywheel is arranged to even out the movement of the pallet track with its rotational energy by conveying kinetic energy to the first power transmission during transfer of a pallet between the upper track and the lower track.

9. The people mover according to claim 1, wherein the rotational energy of the flywheel when the people mover is moving is substantially greater than a kinetic energy of an individual pallet.

10. The people mover according to claim 1, wherein the rotational energy of the flywheel is at least as great as a total kinetic energy of all the pallets when the people mover is moving.

11. The people mover according to claim 1, wherein the inertia of the flywheel is over 0.5 kgm², the speed of rotation of the flywheel is over 200 rpm when the people mover is moving at a drive speed of 0.5-2 m/s, and the mass of an individual pallet is less than 40 kg.

12. The people mover according to claim 1, wherein the flywheel is arranged at an end of the people mover where the pallets rise from the lower track to the upper track.

13. The people mover according to claim 1, wherein the motor is located at one end of the people mover and the flywheel is arranged at an end of the people mover that is opposite the end at which the motor is located.

14. The people mover according to claim 1, wherein the first power transmission includes a transmission chain and a diverting pulley that turns the direction of the transmission chain, and the flywheel is coupled to the diverting pulley.

15. The people mover according to claim 2, wherein the flywheel is coupled by a second power transmission to the first power transmission.

16. The people mover according to claim 15, wherein the first power transmission comprises a transmission chain and a first diverting pulley that guides the transmission chain, and the second power transmission comprises at least one of a belt and a second diverting pulley.

17. The people mover according to claim 15, wherein the people mover comprises two transmission chains connected to the pallets on opposite sides of the pallets, and a synchronization shaft that connects the two transmission chains for movement in synchronization, wherein power is transmitted via the synchronization shaft between the two transmission chains, and the synchronization shaft is coupled to the flywheel by the second power transmission which includes at least one of a belt, chain, diverting pulley and gear wheel.

18. The people mover according to claim 16, wherein the second transmission comprises a third diverting pulley coupled to the flywheel, the second diverting pulley of the second transmission is coupled to the first diverting pulley of the first transmission and the belt of the second transmission couples the second and third diverting pulleys whereby the flywheel is substantially rigidly coupled to the transmission chain via the second transmission.

19. The people mover according to claim 1, further including a handrail belt that forms a loop, wherein the flywheel is inside a projection of the loop formed by the handrail belt as viewed in a direction of the center of a bending of the loop.

20. The people mover according to claim 1, further including a handrail belt that forms a loop, wherein the flywheel is at least partly inside the loop formed by the handrail belt.

21. The people mover according to claim 1, further comprising a handrail belt that forms a loop at an end of the people mover and a handrail casing inside the loop, wherein the flywheel is inside the handrail casing inside the loop.

22. The people mover according to claim 1, further including a support on which the flywheel rests, wherein the support is adapted to be supported on a frame of the people mover or on a floor of a building.

23. The people mover according to claim 18, wherein a transmission ratio between the flywheel and the first diverting pulley is such that the flywheel and first diverting pulley have different angular velocities.

24. The people mover according to claim 16, wherein the flywheel and the first diverting pulley are supported separately from each other.

25. The people mover according to claim 22, wherein the support is supported on the floor, and the support comprises support structures that are separate from a frame of the people mover for conducting forces away from the people mover.

26. The people mover according to claim 1, wherein the flywheel comprises a solid metal disk.

27. The people mover according to claim 1, wherein the flywheel is arranged at an end of the people mover, at which end there is no motor for producing a driving force needed to move the pallets.

28. The people mover according to claim 1, further comprising a braking device arranged to brake the flywheel separately from the first power transmission that moves the flywheel.

29. The people mover according to claim 1, further comprising a coupling arranged between the flywheel and the first power transmission that moves the flywheel that releases the otherwise rigid connection between the flywheel and the first power transmission such that the flywheel continues to rotate although the first power transmission ceases to transmit power or is in the process of ceasing to transmit power to move the pallets.

30. The people mover according to claim 1, wherein the pallets are arranged successively close to each other to form an essentially continuous conveying surface.

31. The people mover according to claim 1, wherein the flywheel comprises a solid object.

32. The people mover according to claim 1, wherein the flywheel has a constant inertia.

33. The people mover according to claim 1, wherein the flywheel is arranged to even out with its rotational energy movement in the travel direction of the pallet track by reducing pulsation caused by a change of direction of the pallets in an area of direction change.

34. A method for evening out movement in a travel direction of a pallet track of a people mover, such as a travelator, moving ramp, escalator or the like, in which a plurality of pallets for carrying and moving people, are arranged one after the other to form an endless track that comprises an upper track section and a lower track section, the people mover comprising an area of direction change of the pallets in which a respective pallet moves between the upper track section and the lower track section, and a motor for producing a driving force is arranged to move the pallets, the method comprising:
employing rotational energy of a flywheel to reduce pulsation caused by a change of direction of the pallets.

35. The method according to claim 34, including connecting the flywheel to a power transmission of the pallet track to reduce the pulsation.

36. The method according to claim 35, wherein the connecting step includes connecting the flywheel essentially rigidly to the power transmission of the pallet track to reduce the pulsation.

37. The method according to claim 34, wherein the employing step includes conveying the rotational energy of the flywheel to the power transmission when moving a pallet from the lower track to the upper track pulsation.

38. The method according to claim 34, wherein the employing step includes placing the flywheel at a first end of the people mover where the pallets rise from the lower track to the upper track, the first end being opposite to a second end at which the motor is arranged.

39. The method according to claim 35, wherein the connecting step includes connecting the flywheel to the power transmission of the pallet track at a non-driven end of the people mover.

40. A people mover such as a travelator, moving ramp, escalator or the like, comprising:
a first power transmission including a transmission chain;
a plurality of pallets connected to the transmission chain and arranged one after the other to form an endless track for carrying and moving people, the track having an upper track section, a lower track section, and an area of direction change of the pallets in which area a pallet is arranged to move between the upper track section and the lower track section, the pallets being arranged successively close to each other to form an essentially continuous conveying surface;
a movable diverting pulley that turns a direction of the transmission chain;
a rotating apparatus;
a unit movable in a horizontal direction for tensioning the transmission chain, wherein the movable unit includes tensioning wheels, and the movable diverting pulley moves along with the unit when the unit is moved;
a second power transmission including a second diverting pulley coupled to the first diverting pulley, a third diverting pulley coupled to the rotating apparatus and a belt coupling the second and third diverting pulleys, the second power transmission transmitting rotational movement between the rotating apparatus and the movable diverting pulley, wherein the rotating apparatus is supported in position in a manner allowing rotation, wherein the tensioning wheels are arranged to tension the tensioning belt, at least one tensioning wheel being spring-loaded to move towards the tensioning belt, wherein the tensioning wheels are arranged such that at least one of the tensioning wheels steers the tensioning belt to form an angle in the tensioning belt.
